(19) United States
(12) Patent Application Publication
(10) Pub. No.: US 2012/0169919 A1
(43) Pub. Date: Jul. 5, 2012

(54) CAMERA SUPPORT DEVICE

(75) Inventor: Rafael HUERTOS SANZ, Madrid (ES)

(73) Assignee: EADS CONSTRUCCIONES AERONAUTICAS, S.A.

(21) Appl. No.: 13/225,605

(22) Filed: Sep. 6, 2011

(30) Foreign Application Priority Data
Dec. 30, 2010 (ES) 201032003

(51) Int. Cl. H04N 5/225

(52) U.S. Cl. 348/373; 348/E05.024

(57) ABSTRACT

Support device (10) for a camera (1) situated on the outer surface of an aircraft, which comprises a housing element (2) which houses internally the camera (1) and an external aerodynamic element (6) which covers externally the device (10), said device comprising support means (4) and adjusting elements (12) such that, when the adjusting elements (12) are tightened, the support means (4) keep the housing element (2) and the camera (1) in a fixed position and with a fixed orientation so that pictures may be taken by the camera (1) and, when the adjusting elements (12) are not tightened, the housing element (2) and the camera (1) may be rotated with three degrees of freedom relative to the support means (4).

### FIELD OF THE INVENTION

The present invention relates to a support device for a camera, in particular a camera for viewing aircraft flight tests.

### PRIOR ART

During the in-flight tests of an aircraft it is often required to record different aspects of a given test, whether it be the aerodynamic behaviour of movable surfaces of the aircraft, or other aspects, visual verification of which cannot be performed by the aircraft crew because of physical obstacles, or flight characteristics which must be recorded to obtain civil or military certification of the aircraft.

Traditionally cameras have been installed for this purpose on the inside or of outside an aircraft so that the abovementioned aspects or characteristics may be suitably recorded. In the case of cameras which are to be installed on the outside of the aircraft, the support devices for carrying said cameras must be made to a high specification on account of the aerodynamic loads which they must withstand; at the same time, these support devices must be sufficiently flexible for them to be used in different tests, with different objects, but without the need for major and hence unnecessarily time-consuming operations on-board the plane in order to perform adjustment of these support devices in the case of different tests or test conditions.

Technological progress during the last few years in the sector of recording devices has resulted in cameras which are increasingly smaller such that the devices required to support them are in turn increasingly smaller in size and lighter, thus allowing designers to install a greater number of cameras on the outside of aircraft for different purposes.

During aircraft in-flight tests, especially in the case of aircraft which have large-size aerofoils, it is frequently noted that the object to be viewed by means of the camera has moved significantly during the flight, such that the directional settings of the camera performed on-ground do not necessarily coincide with the orientation which is required when flying and, therefore, frequently the position of the camera must be corrected in between flights of the aircraft.

Various devices for supporting cameras on the outside of an aircraft are known from the prior art. For example, the document U.S. Pat. No. 5,426,476 describes a support device for an aircraft camera which can be mounted and removed in a quick and easy manner, said camera being arranged preferably on the aircraft wing in order to take aerial photographs and this camera being large and heavy. The movement of said camera is controlled remotely by the operator on-board the aircraft, allowing the camera to be moved through 360° about a horizontal axis and more than 90° about a vertical axis. U.S. Pat. No. 5,365,291 describes a large and heavy camera for taking aerial photographs which moves between a retracted position, close to the fuselage, and an extended position, for taking photographs. The movement of the camera between the retracted and extended positions is performed by means of an actuator which is operated by a motor so that, in the extended position, the camera is able to take photographs without objects obstructing the vision. Other documents, such as U.S. Pat. No. 5,531,403 and U.S. Pat. No. 1,829,142, describe large and heavy camera support devices, these cameras being able to be adjusted remotely and during the flight. The problems posed by the solutions mentioned is that, although they are effective for large-size and heavy cameras, they represent systems which are not suitable for use in small-size cameras, such as those which are customarily used nowadays. Thus, the devices mentioned in the prior art documents are designed to support large-size cameras which are generally controlled remotely: these existing devices are designed for different kinds of remote operation and are too complex for them to be used in the case which concerns us here, i.e. principally aimed at measuring deformations of aerofoils during flight of an aircraft using a small-size camera which must be kept in a permanently fixed position which moreover may vary between aircraft flights.

In turn, the document U.S. Pat. No. 4,174,162 describes a system for mounting cameras on the outside of an aircraft, said cameras being intended for aerial photography. This prior system allows movement of the camera to a very limited degree, by means of the control rod and an adjustable connecting device, so that the camera and the control rod may be moved only in a vertical plane, thereby ensuring that the camera always remains level. The problem of this kind of solution is that it does not have sufficient flexibility to cater for a wide range of possible orientations of the camera suitable for different conditions which may arise during different flight tests.

Generally speaking, the problems of the solutions represented by camera support devices such as those described consist, on the one hand, in the major difficulties encountered when adjusting the arrangement of the camera for each test which is to be performed in the aircraft. Furthermore, these known solutions pose the problem that they must undergo major structural modifications when they are to be installed on different aircraft or on different surfaces within the same aircraft. On the other hand, these solutions require modification of the design of the device or arrangement or else require additional adjustments in order to compensate for the deformations arising between the aircraft surfaces where the cameras are arranged and the object which is being observed, thus ensuring that the pictures taken are accurate.

It would therefore be desirable to provide a support device for aircraft cameras, said cameras being small in size, such that the same design of said support device may be maintained for a given position on the outer surface of the aircraft, without thereby preventing the camera from being able to be oriented in an easy and versatile manner so as to allow focusing on the object concerned during each flight test as well as adjustment and rectification of the camera orientation in order to correct the variation in position of the object to be observed, due to intrinsic deformations of the aircraft structure in flight conditions (for example, the relative position of the wing tip with respect to the fuselage, the relative position of vertical stabilizers or horizontal stabilizers with respect to the fuselage, or the relative position of the wing and stabilizers, etc.).

The present invention is therefore intended to provide a support device for a camera such as those which are generally used for in-flight tests of aircraft, whereby said camera is able to be adjusted before the test so as to focus on the test object, while at the same time the said device is able to combine maximum rigidity with minimum weight.

The object of the present invention is to solve the aforementioned problems.

### SUMMARY OF THE INVENTION

Thus, the present invention relates to a support device for a camera, in particular a camera for viewing flight tests of aircraft, such as those customarily used to provide recorded proof of different aspects to be examined during the said in-flight tests, such as: displacement of movable surfaces, release of objects such as torpedoes or ejectable fuel tanks, ice formation on aerofoils, deployment of refuelling booms during in-flight refuelling operations, and many other aspects from among those which are customarily examined during in-flight tests when designing a new aircraft or when modifying already existing aircraft. Although the cameras mentioned have been described as being used supported by means of the support device according to the invention during stages of in-flight tests and design of an aircraft, these cameras may also be used in different applications during what may be regarded as the working life of the aircraft, being supported by the support device according to the invention.

With the support device according to the invention the camera contained inside it may perform a recording in any direction of the available field of vision without the need for remote control and allows a fixed field of vision to be maintained and a comparison of the different photograms taken by the camera, while allowing different focusing or lenses for different tests. Thus, the device according to the invention allows adjustment of the lens of the camera in the desired direction for each test and may be installed on any outer surface of the aircraft by adapting a support element of said device to the front outer surface of the aircraft on which it is arranged.

Moreover, the above device allows precise adjustment of the camera in order to compensate for existing deformations between the different surfaces of the aircraft where the camera is installed together with the support device, and the object in question, since, owing to these deformations, the targeted object may remain outside of the field of vision of the camera or result in the need for additional adjustments. These adjustments, owing to the design of the support device which will be described more clearly below, may be performed without having to modify either the external fairing protecting the camera or the supports on which the camera is arranged. Thus, the support device according to the invention comprises a housing element containing internally the camera, so that the housing element and the camera are able to rotate together in order to orient and position said camera. Since the housing element is situated inside the external aerodynamic fairing which protects the camera, the main advantage offered by this configuration of the support device according to the invention is that the form of the external assembly is not modified even when the camera is adjusted, since the housing element rotates (together with the camera) inside the said external fairing which remains unvaried.

The aforementioned objects are achieved by a support device for a camera, in particular a camera for viewing flight tests of aircraft, according to the invention, which comprises:
a housing element, intended to house internally the camera for performing viewing of flight tests of the aircraft, such that the camera and the housing element rotate together in order to position the said viewing camera;
a protection element, arranged between the camera and the housing element, said element protecting the camera from any possible damage which might occur when mounting the camera on the housing element;
support means, having the function of keeping the housing element, and therefore the camera, with the desired orientation for viewing the targeted object;
a support bracket, which adapts the device to the geometry of the aerodynamic surface of the aircraft on which the said device is fixed and which is designed specifically for each surface on which the viewing camera is to be arranged;
an external aerodynamic element, intended to protect externally the entire assembly of the support device together with the viewing camera and being oriented so as to reduce the aerodynamic forces of the assembly and specifically designed for each surface on which the viewing camera is to be arranged;
adjusting elements, which allow the support means to be loosened or tightened, thus allowing orientation of the housing element and, together therewith, orientation of the viewing camera; and
fixing elements, which have the function of fixing the viewing camera inside the housing element so that both of them move together.

Other characteristic features and advantages of the present invention will emerge from the following detailed description with reference to the accompanying figures.

### DESCRIPTION OF THE FIGURES

FIG. 1 shows a diagram of the support device for a camera for viewing flight tests of an aircraft, according to the invention, said device being arranged on the outside of a surface of the aircraft.

FIG. 2 shows the parts which make up the support device for a camera for viewing flight tests of an aircraft, according to the invention.

FIG. 3 shows in detail the main parts which make up the support device for a camera for viewing flight tests of an aircraft, according to the invention.

FIG. 4 shows in detail an exploded view of the main parts of the device according to the invention shown in FIG. 3.

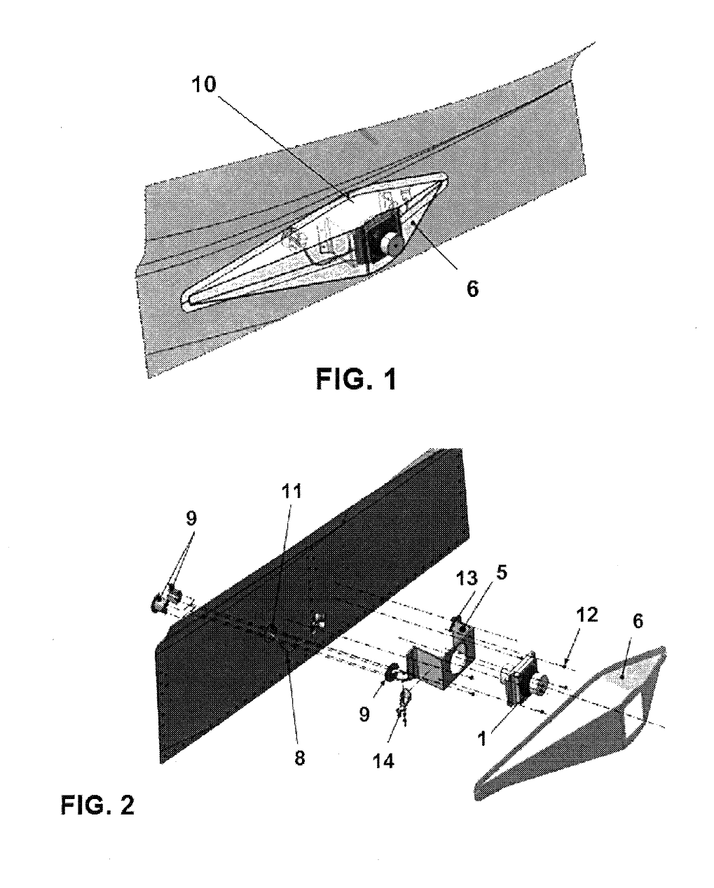

### DETAILED DESCRIPTION OF THE INVENTION

The invention thus illustrates a support device 10 for a camera 1, in particular a camera 1 for viewing flight tests of an aircraft. The support device 10 according to the invention comprises:
a housing element 2, which comprises preferably externally semi-spherical parts, in particular in the form of two semi-spheres, which house internally the camera 1 (see FIG. 4), said housing element 2 reproducing internally the shape of the camera 1 so that the latter is fixed to said housing element 2, such that the camera 1 and the housing element 2 rotate together relative to the support means 4 with three degrees of freedom;
a protection element 3, in particular a seal made of rubber or similar elastic material, arranged between the camera 1 and the housing element 2 and intended to reduce the damage which the camera 1 might suffer as a result of the housing element 2 when the camera 1 is mounted on the said element 2, preventing moreover the camera 1 from being damaged during flying of the aircraft, as a result of vibrations or other stresses, said protection element 3 moreover having the function of providing protection against the entry of moisture inside the space enclosed by the external aerodynamic element 6;
support means 4, in particular two support halves, which have the function of keeping the housing element 2, and therefore the camera 1, in the required position and with the necessary orientation for the test;
a support element 5, in particular an ordinary bracket, which adapts the device 10 to the geometry of the aerodynamic surface of the aircraft on which the said device 10 is fixed and which is specifically designed for each surface on which the viewing camera 1 is to be arranged;
an external aerodynamic element 6, in particular a fairing, which covers externally the device 10, preventing possible adverse aerodynamic effects, and is designed specifically for each surface on which the viewing camera 1 is to be arranged;
adjusting elements 12, such as threaded bolts or screws, which allow loosening or tightening of the support means 4, allowing orientation of the housing element 2 and, together therewith, orientation of the viewing camera 1; and
fixing elements 7, such as bolts, nuts, screws and washers, which have the function of fixing the camera 1 inside the housing element 2, so that said housing element 2 rotates together with the viewing camera 1.

With the device 10 according to the invention, the camera 1 may be installed on different surfaces of the aircraft, such as wings, vertical stabilizers or horizontal stabilizers, engine nacelles or other surfaces.

The object of the present invention is therefore to provide a support device 10 for image recording cameras 1, using this device 10 mainly during the aircraft in-flight tests and preferably in those zones of the aircraft where it is of utmost importance to know the behaviour of given parts of said aircraft when in flight.

The support bracket 5 is adapted to the geometrical conditions of the surface of the aircraft on which it rests, said element being structurally strong and able to withstand the stresses to which it may be subject during use, comprising the necessary elements for supporting the main parts of the device 10, as described below and as can be seen in its entirety in FIG. 2.

The external aerodynamic element 6, in particular a fairing, is installed on top of the entire assembly in order to protect it from the influence of air and minimize the forces due to friction and also protect the wiring 8—shown in FIG. 2—necessary for the camera 1.

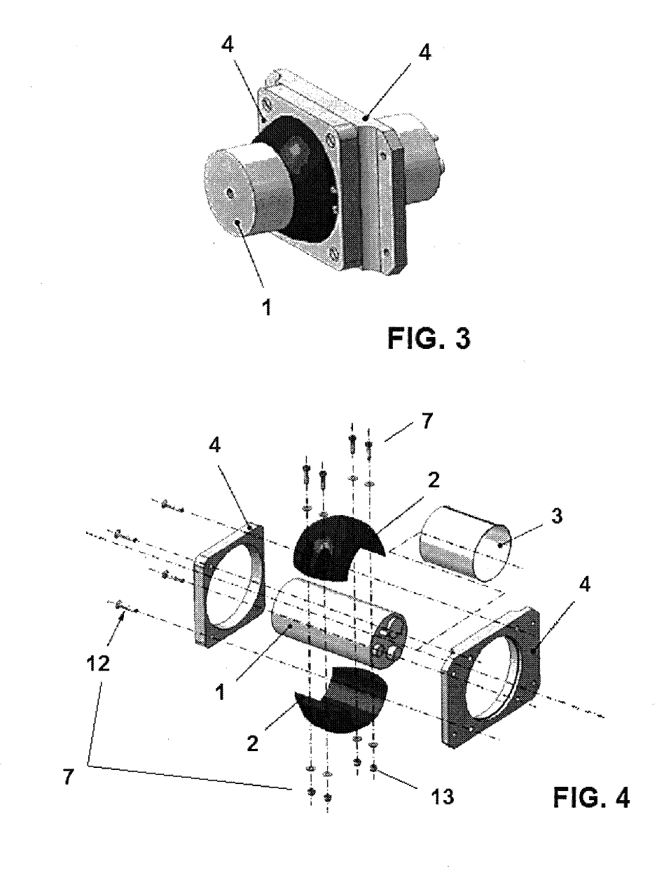

Once the support bracket 5 has been fixed to the surface of the aircraft being examined, after installing the wiring 8 together with the wiring grommets 9 which prevent the introduction of moisture inside the aircraft and are fitted onto a grommet borehole 11, the assembly which can be seen in FIG. 3, formed by the support means 4, the camera 1, the housing element 2 and the protection element 3, is fixed to the support bracket 5 by means of the adjusting elements 12, preferably threaded bolts or screws (see FIG. 2). Once the above assembly is in this position, the object to be examined is chosen within the field of vision of the camera 1: in order to achieve this effect, the adjusting elements 12 are partially loosened so that it is possible to rotate the housing element 2 together with the viewing camera 1 (since the camera 1 and the housing element 2 are fixed by means of the fixing elements 7) in the desired direction until the object to be examined is aligned within the field of vision of the camera 1, following which the said adjusting elements 12 may be tightened again so as to fix the desired orientation of the camera 1.

Once the camera 1 is arranged with the desired orientation, the wiring 8 must be suitably fixed on a holder 14 so that correct operation of the camera 1 is ensured, without the wiring 8 causing stresses or strains.

Once the camera 1 has been oriented in the desired position, the external aerodynamic element 6 is mounted on the front assembly so that the entire device 10 is protected from the external influence of the air which might affect the camera 1 and induce undesirable vibrations or effects in the image taken by said camera. The external aerodynamic element 6 is fixed preferably by means of screws along its entire perimeter or by any other means for performing connection to the outer surface of the aircraft.

Subsequently, each time it is required to adjust the orientation of the camera 1, the sequence to be followed will be the same as that mentioned above, namely: loosening of the adjusting elements 12, orientation of the housing element 2 along with the camera 1 in the desired position and then tightening again of the adjusting elements 12 so as to fix the orientation of the camera 1.

Thus, according to the design of the support device 10 according to the invention, it is possible to perform movement of the viewing camera 1, together with movement of the housing element 2 (since the camera 1 and the housing element 2 are fixed by means of the fixing elements 7), with three degrees of freedom of rotation relative to the support means (4), in a position where the adjusting elements 12 allow loosening of the support means 4, which then allow rotation of the housing element 2, together with the camera 1. The fixed position of the camera 1, by means of rigid fixing thereof inside the housing element 2, is obtained in a position where the adjusting elements 12 fix the support means 4, preventing movement thereof.

Although the present invention has been described entirely in connection with preferred embodiments, it is evident that it may be subject to those modifications falling within the scope of the following claims, said invention not being regarded as limited by the above embodiments.

1. Support device (10) for a camera (1) situated on the outer surface of an aircraft, which comprises a housing element (2) which houses internally the camera (1) and an external aerodynamic element (6) which covers externally the device (10), characterized in that it comprises support means (4) and adjusting elements (12) such that, when the adjusting elements (12) are tightened, the support means (4) keep the housing element (2) and the camera (1) in a fixed position and with a fixed orientation so that pictures may be taken by the camera (1) and, when the adjusting elements (12) are not tightened, the housing element (2) and the camera (1) may be rotated, with three degrees of freedom, relative to the support means (4).

2. Device (10) according to claim 1, wherein the external aerodynamic element (6) allows, without being disassembled, access to the adjusting elements (12), consequently allowing rotation of the housing element (2) and the camera (1) in order to orient said camera (1).

3. Device (10) according to claim 1, which also comprises a support element (5) in the form of a bracket specifically designed for the outer surface of the aircraft on which the camera (1) is arranged, such that said support element (5) adapts the device (10) to every geometry of the surface of the aircraft.

4. Device (10) according to claim 1, wherein the support means (4) comprise two support halves.

5. Device (10) according to claim 1, wherein the housing element (2) comprises externally semi-spherical parts which allow rotation of said housing element (2) relative to the support means (4) with three degrees of freedom, said camera (1) being fixed to the housing element (2) by means of fixing elements (7).

6. Device (10) according to claim 5, wherein the externally semi-spherical parts reproduce internally the shape of the camera (1).

7. Device (10) according to claim 5, wherein the externally semi-spherical parts are two semi-spheres.

8. Device (10) according to claim 1, also comprising a protection element (3) which is arranged between the camera (1) and the housing element (2), which dampens vibrations above the camera (1) and which sealingly closes the external aerodynamic element (6) in the assembly of the device (10).

9. Device (10) according to claim 8, wherein the protection element (3) comprises a seal made of rubber or an elastic material.

10. Device (10) according to claim 1, wherein the adjusting elements (12) comprise threaded bolts and nuts (13).

11. Device (10) according to claim 1, wherein the adjusting elements (12) comprise screws and nuts (13).

12. Device (10) according to claim 1, which comprises wiring (8) together with wiring grommets (9) fitted onto a grommet borehole (11) for performing connection of the camera (1).
